(19) United States
(12) Patent Application Publication
(10) Pub. No.: US 2009/0010007 A1
(43) Pub. Date: Jan. 8, 2009

(54) Recessed Lighting Fixture

(75) Inventor: Giuseppe Caluori, Dollard-des-Ormeaux (CA)

Correspondence Address: MIDDLETON & REUTLINGER, 2500 BROWN & WILLIAMSON TOWER, LOUISVILLE, KY, 40202, US

(73) Assignee: Canlyte, Inc., Lachine (CA)

(21) Appl. No.: 11/428,893

(22) Filed: Jul. 6, 2006

Related U.S. Application Data
(60) Provisional application No. 60/697,608, filed on Jul. 8, 2005.
(60) Provisional application No. 60/774,452, filed on Feb. 17, 2006.

(51) Int. Cl. F21V 21/00; H01J 9/00

(52) U.S. Cl. 362/366; 445/23

(57) ABSTRACT

Disclosed herein is a recessed lighting fixture, comprising a housing having a back wall, one or more side walls extending from the back wall and at least one lower lip extending outwardly from one of said side walls, one or more of said side walls including at least one elongate slot formation, the slot formation including aligned upper and lower slot portions, the upper and/or lower slot portions having a pair of oppositely extending slot boundary regions, at least one slot boundary region having a lateral slot extension therei the slot extension having a first elongate dimension, a retaining clip for mounting in the slot formation for movement therealong, the retaining clip having a head portion, a neck portion and a body portion, the neck portion being dimensioned to extend through the upper slot portion and the head portion arranged to travel along an inner surface of the corresponding side wall on opposite sides of the upper slot portion, the neck portion including a collar portion, the collar portion including one or more than one projection extending laterally outwardly from the neck portion, the collar portion having a second elongate dimension exceeding the first elongate dimension to permit the collar portion to travel on an outer surface of a corresponding wall over the lateral slot extension, the body portion arranged to be biased outwardly front the housing portion and joined to an anchor portion, the anchor portion extending through the lower slot portion with an anchor flange, the anchor flange being arranged to travel along an inner surface of the corresponding side wall on opposite sides of the lower slot portion, the head and/or anchor portions being dimensioned to pass through a corresponding slot extension in the upper and/or lower slot portions.

### CROSS-REFERENCE TO RELATED APPLICATIONS

The entire subject matter of U.S. Provisional application Ser. No. 60/697,608, filed Jul. 8, 2005 and entitled RECESSED LIGHTING FIXTURE is incorporated by reference. The applicants claim priority benefit under Title 35, United States Code, Section 119 of U.S. Provisional application Ser. No. 60/697,608, filed Jul. 8, 2005 and entitled RECESSED LIGHTING FIXTURE.

The entire subject matter of U.S. Provisional application Ser. No. 60/774,452, filed Feb. 17, 2006 and entitled RECESSED LIGHTING FIXTURE is also incorporated by reference.

### STATEMENT REGARDING FEDERALLY SPONSORED RESEARCH OR DEVELOPMENT

Not applicable.

### REFERENCE TO A “SEQUENTIAL LISTING,” A TABLE, OR A COMPUTER PROGRAM LISTING APPENDIX SUBMITTED ON A COMPACT DISC

Not applicable.

### BACKGROUND OF THE INVENTION

1. Field of the Invention

The present invention relates to recessed lighting fixtures.

2. Description of the Related Art

Recessed light fixtures, often called “pot lights”, are in widespread use in residential and commercial premises. They appeal to designers both for the fact that they take up virtually no space in a room, being recessed into the ceiling, and for their aesthetic versatility and appeal.

A typical recessed light fixture comprises a housing, which is usually cylindrical, a socket for receiving a floodlight, halogen bulb or other lamp, and a housing trim for aesthetic purposes which is affixed over the mouth of the housing after the housing has been mounted into the ceiling and covers the housing flange.

An example of a recessed lighting fixture is disclosed in U.S. Pat. No. 5,609,414, issued Mar. 11, 1997, entitled RECESSED LIGHTING FIXTURE, in which a pair of outwardly biased retaining clips is mounted in a housing. The entire subject matter of U.S. Pat. No. 5,609,414, issued Mar. 11, 1997, entitled RECESSED LIGHTING FIXTURE, is incorporated by reference.

While conventional recessed lighting fixtures well serve their intended purpose, they have limited use in some applications. It would be desirable to provide further improvements to such lighting fixtures.

### SUMMARY OF THE INVENTION

In one of its aspects, the present invention provides a recessed lighting fixture, comprising a housing having a back wall, one or more side walls extending from the back wall and at least one lower lip extending outwardly from one of said side walls, one or more of said side walls including at least one elongate slot formation, the slot formation including aligned upper and lower slot portions, the upper and/or lower slot portions having a pair of oppositely extending slot boundary regions, at least one slot boundary region having a lateral slot extension therein, the slot extension having a first elongate dimension, a retaining clip for mounting in the slot formation for movement therealong, the retaining clip having a head portion, a neck portion and a body portion, the neck portion being dimensioned to extend through the upper slot portion and the head portion arranged to travel along an inner surface of the corresponding side wall on opposite sides of the upper slot portion, the neck portion including a collar portion, the collar portion including one or more than one projection extending laterally outwardly from the neck portion, the collar portion having a second elongate dimension exceeding the first elongate dimension to permit the collar portion to travel on an outer surface of a corresponding wall over the lateral slot extension, the body portion arranged to be biased outwardly from the housing portion and joined to an anchor portion, the anchor portion extending through the lower slot portion with an anchor flange, the anchor flange being arranged to travel along an inner surface of the corresponding side wall on opposite sides of the lower slot portion, the head and/or anchor portions being dimensioned to pass through a corresponding slot extension in the upper and/or lower slot portions. In some embodiments, the upper slot portion has a pair of opposed slot extensions.

In some embodiments, the lateral portions include a pair of opposed projections.

In some embodiments, the body portion has a relatively smaller lateral dimension than the collar portion.

In some embodiments, the lateral slot extensions are located in a lower region of the upper and/or lower slot portions.

In some embodiments, the lateral slot extensions are located in an upper region of the upper and/or lower slot portions.

In some embodiments, the lateral slot extensions are located in a central region of the upper and/or lower slot portions.

In some embodiments, the lateral slot extensions are located in the upper slot portion, each slot extension having a first elongate dimension.

In some embodiments, the projection has a second elongate dimension that exceeds the first elongate dimension.

In some embodiments, the head portions include a pair of contact regions for contacting inner surface of the corresponding side wall portion, the head portions further comprising a pair of ears, each located adjacent a corresponding contact region.

Some embodiments further comprise a mounting flange extending inwardly from a lower periphery of the upper slot portion.

In some embodiments, the head portion further comprises a first passage, the mounting flange having a second passage, and a fastener threadably engaged with and extending through the first and/or second flanges for adjusting the head portion relative to the mounting flange.

In some embodiments, the upper slot portion is wider than the lower slot portion.

In some embodiments, the upper slot portion is narrower than the lower slot portion.

In some embodiments, the collar portion and the body portion are of equal lateral dimension.

In some embodiments, the collar portion and the body portion are joined at a bend.

In another of its aspects, the present invention provides a retaining clip for use in a recessed lighting fixture of the type having a housing with at least one side wall, one or more of said side walls including aligned upper and lower slot portions, the upper and/or lower slot portions having a pair of oppositely extending slot boundary regions, at least one slot boundary region having a lateral slot extension therein, the slot extension having a first elongate dimension, the retaining clip arranged for mounting in the slot formation for movement therealong, the retaining clip comprising a head portion, a neck portion and a body portion, the neck portion being dimensioned to extend through the upper slot portion and the head portion arranged to travel along an inner surface of the corresponding side wall on opposite sides of the upper slot portion, the neck portion including a collar portion, the collar portion including one or more than one projection extending laterally outwardly from the neck portion, the collar portion having a second elongate dimension exceeding the first elongate dimension to permit the collar portion to travel on an outer surface of a corresponding wall over the lateral slot extension, the body portion arranged to be biased outwardly from the housing portion and joined to an anchor portion, the anchor portion extending through the lower slot portion with an anchor flange, the anchor flange being arranged to travel along an inner surface of the corresponding side wall on opposite sides of the lower slot portion, the head and/or anchor portions being dimensioned to pass through a corresponding slot extension in the upper and/or lower slot portions.

In another of its aspects, the present invention provides a method of forming a recessed lighting fixture, comprising the steps of:
providing a housing with a back wall, one or more side walls extending from the back wall and at least one lower lip extending outwardly from one of said side walls;
providing one or more of said side walls with aligned upper and lower slot portions,
providing at least one lateral slot extension in a boundary region of a least one slot boundary regions and with a first elongate dimension,
providing a retaining clip for mounting in the upper and lower slot portions with a head portion, a neck portion and a body portion;
providing the neck portion with a dimension allowing it to extend through the upper slot portion, so that the head portion can travel along an inner surface of the corresponding side wall on opposite sides of the upper slot portion,
providing the neck portion with a collar portion with one or more than one projection extending laterally outwardly therefrom,
providing the collar portion with a second elongate dimension exceeding the first elongate dimension to permit the collar portion to travel on an outer surface of a corresponding wall over the lateral slot extension,
arranging the body portion to be biased outwardly from the housing portion and joined to an anchor portion with an anchor flange,
arranging the anchor portion to extend through the lower slot portion with an anchor flange,
arranging the anchor flange to travel along an inner surface of the corresponding side wall on opposite sides of the lower slot portion, and
arranging the head and/or anchor portions being dimensioned to pass through a corresponding slot extension in the upper and/or lower slot portions.

In yet another of its aspects, the present invention provides a method of forming a recessed lighting fixture, comprising the steps of:
providing a housing with a back wall, one or more side walls extending from the back wall and at least one lower lip extending outwardly from one of said side walls;
providing one or more of said side walls with aligned upper and lower slot portions,
providing at least one lateral slot extension in a boundary region of at least one slot boundary regions and with a first elongate dimension,
providing a retaining clip for mounting in the upper and lower slot portions with a head portion, a neck portion and a body portion, the neck portion having a dimension allowing it to extend through the upper slot portion, so that the head portion can travel along an inner surface of the corresponding side wall on opposite sides of the upper slot portion, the neck portion having a collar portion with one or more than one projection extending laterally outwardly therefrom, the collar portion having a second elongate dimension exceeding the first elongate dimension; the body portion being arranged to be biased outwardly from the housing portion and joined to an anchor portion with an anchor flange on a free end region thereof,
installing the clip on the housing by passing the head and/or anchor portions through a corresponding slot extension in the upper and/or lower slot portions, so that the anchor flange is able to travel along an inner surface of the corresponding side wall on opposite sides of the lower slot portion, and to enable the collar portion to travel on an outer surface of a corresponding wall over the lateral slot extension.

In another of its aspects, the present invention provides a method of forming a recessed lighting fixture, comprising:
a step for providing a housing with a back wall, one or more side walls extending from the back wall and at least one lower lip extending outwardly from one of said side walls, one or more of said side walls with aligned upper and lower slot portions, and at least one lateral slot extension in a boundary region of at least one slot boundary regions and with a first elongate dimension,
a step for providing a retaining clip for mounting in the upper and lower slot portions with a head portion, a neck portion and a body portion, the neck portion having a dimension allowing it to extend through the upper slot portion, so that the head portion can travel along an inner surface of the corresponding side wall, the neck portion having a collar portion with one or more than one projection extending laterally outwardly therefrom, the collar portion having a second elongate dimension exceeding the first elongate dimension, the body portion being arranged to biased outwardly from the housing portion and joined to an anchor portion with an anchor flange on a free end region thereof, and
a step for installing the clip on the housing by passing the head and/or anchor portions through a corresponding slot extension in the upper and/or lower slot portions, so that the anchor flange is able to travel along an inner surface of the corresponding side wall on opposite sides of the lower slot portion, and to enable the collar portion to travel on an outer surface of a corresponding wall over the lateral slot extension.

In another of its aspects, the present invention provides a recessed lighting fixture, comprising housing means having a back wall means, one or more side wall means extending from the back wall means and at least one lower boundary means extending outwardly from one of said side wall means, one or more of said side wall means including at least one elongate slot means, the slot means including aligned upper and lower slot portions, the upper and/or lower slot portions having a pair of oppositely extending slot boundary regions, at least one slot boundary region having a lateral slot extension therein, the slot extension having a first elongate dimension, a retaining means for mounting in the slot means for movement therealong, the retaining means having a head portion, a neck portion and a body portion, the neck portion being dimensioned to extend through the upper slot portion and the head portion arranged to travel along an inner surface of the corresponding side wall, the neck portion including a collar portion, the collar portion including one or more than one guide means extending laterally outwardly from the neck portion, the collar portion having a second elongate dimension exceeding the first elongate dimension to permit the guide means to travel on an outer surface of a corresponding wall over the lateral slot extension, the body portion arranged to be biased outwardly from the housing portion and joined to an anchor means, the anchor means extending through the lower slot portion with an anchor flange, the anchor flange being arranged to travel along an inner surface of the corresponding side wall on opposite sides of the lower slot portion, the head and/or anchor portions being dimensioned to pass through a corresponding slot extension in the upper and/or lower slot portions.

### BRIEF DESCRIPTION OF THE DRAWINGS

Several preferred embodiments of the present invention will now be described by way of example only, with reference to the appended drawings in which:

FIG. 1 is a fragmentary perspective view of a recessed lighting fixture;

FIG. 2 is a perspective view of a portion of the fixture of FIG. 1;

FIGS. 3 and 4 are perspective views of another portion of the fixture of FIG. 1;

FIGS. 5 to 10 are perspective views of other recessed lighting fixtures or portions thereof;

FIG. 10a is a sectional view of the fixture shown in FIG. 10; and

FIG. 11 is a perspective view of still another recessed lighting fixture.

### DESCRIPTION OF THE PREFERRED EMBODIMENTS

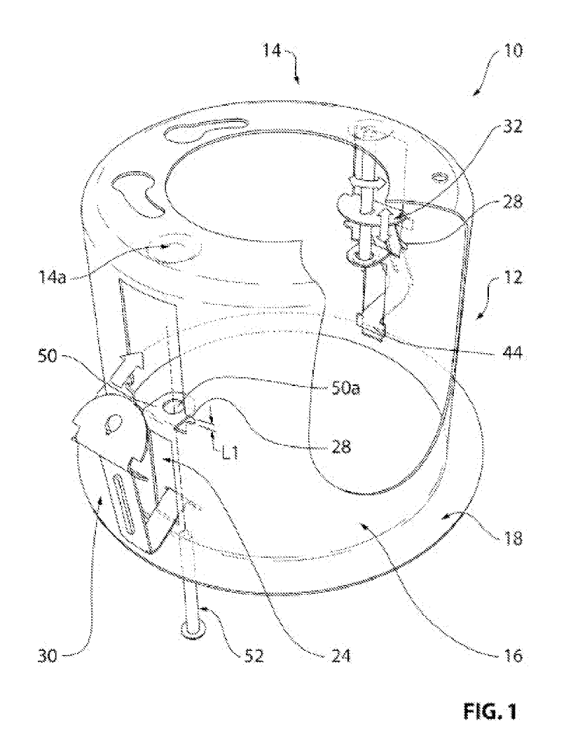

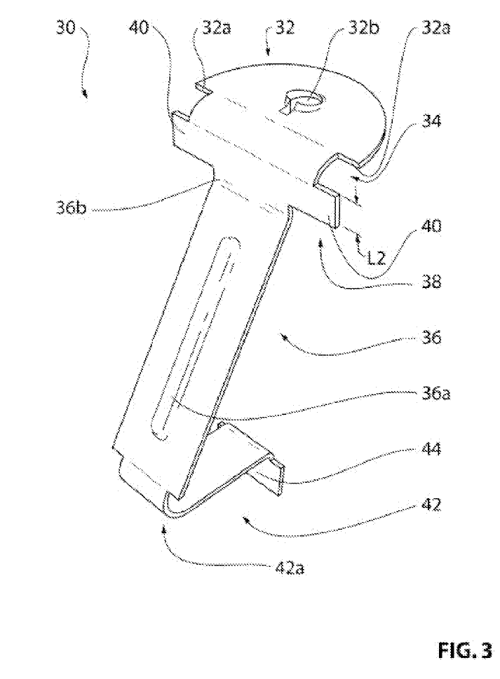

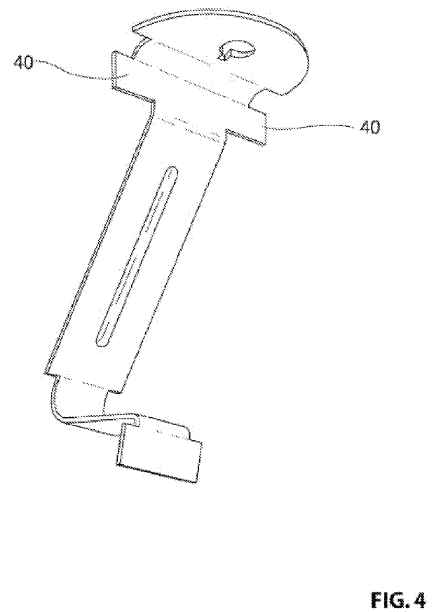

Referring to the FIGS. 1 to 4, there is provided a recessed light fixture 10 having a cylindrical cup shaped housing 12 having a back wall 14 with a cylindrical side wall 16 extending from the back wall 14. A lower lip 18 extends outwardly from the side wall 16.

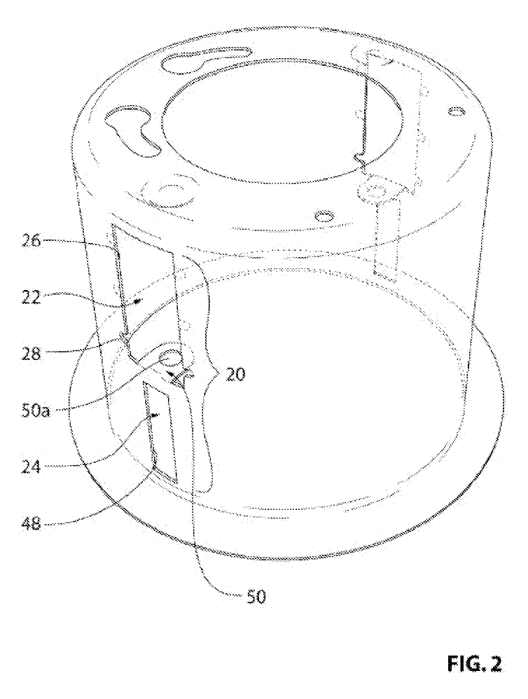

As can best be seen in FIG. 2, the side wall includes a pair of elongate slot formations 20. Each slot formation 20 includes aligned upper and lower slot portions 22, 24 respectively. In this case, the upper slot portion 22 is wider than the lower slot portion 24. However, the upper and lower slot portions 22, 24 may be of other relative dimensions. They may, for instance, be of the same width or the lower slot portion may be wider than the upper slot portion. Each upper slot portion 22 has a pair of oppositely extending upper slot boundary regions 26. Each boundary region 26 has a later slot extension 28 therein and each slot extension 28 has a first elongate dimension L1, as shown in FIG. 1.

Referring to FIGS. 1, 3 and 4, a retaining clip 30 is mounted to the slot formations 22, 24 for movement therealong, both axially and radially relative to the housing 12, as will be described. The retaining clip 30 has a head portion 32, a neck portion 34 and a body portion 36. The head portion 32 is dimensioned to pass through a corresponding pair of the slot extensions 28 in the upper slot portion 22.

The neck portion 34 is dimensioned to extend through the upper slot portion 22 and the head portion 32 has a pair of edge regions 32a which are arranged to travel along an inner surface of the side wall 16 on opposite sides adjacent the upper slot boundary regions 26 of the upper slot portion 22. The neck portion 34 includes a collar portion 38 which has a pair of opposed projections 40 extending laterally outwardly from opposite sides thereof.

It can be seen that each collar portion 38 has a second elongate dimension L2 which exceeds the first elongate dimension L1 to permit the collar portion 38 to travel on an outer surface of the side wall 16 over the corresponding lateral slot extension 28. However, there may be other differences between the collar portion 38 and the lateral slot extensions 28 that enable the collar portion 38 to travel on the outer surface of the side wall.

The body portion 36 has a central ridge 36a for stiffening purposes and has a relatively smaller lateral dimension than the collar portion 38. The body portion 36 is also joined to an anchor portion 42 at a bend 42a. The anchor portion 42 extends from the body portion 36 to an anchor flange 44, the latter of which itself is arranged to travel along an inner surface of a pair of lower slot boundary regions 48 on opposite sides of the lower slot portion 24, as shown in FIG. 1. In addition, the head, neck, body and anchor portions are formed from a one piece member that is formed of resilient materials, most preferably spring steel. However, other materials are contemplated such as plastics and the like for some applications. The body portion 36 is also arranged to be biased outwardly from the side wall 16. The outer bias, in this case, is provided by a bend 36b between the body portion 36 and the collar portion 38 and the contact of 32a on upper slot boundary regions 26.

Extending from the lower periphery of the upper slot portion 22 is a mounting flange 50 with a passage 50a which is aligned with a concave seat 14a formed by a projection formed in the back wall 14. The head portion 32 is further provided with a passage 32b which, together with the passage 50a and seat 14a, receives a fastener, in the form of an adjusting screw 52. The latter extends through the passages 50a and 32b and abuts the interior recessed surface of the seat 14a.

As can be viewed in FIG. 2, the lateral slot extensions 28 may be located in a number of locations in the upper slot portion 22, including a lower region as shown in solid lines, or in a central region or upper region as shown in dashed lines.

Thus, as shown in FIG. 1, the retaining clip 30 is installed in the housing 12 by first tilting the anchor flange 44 to pass through the lower slot portion 24. The retaining clip 30 may then be righted to its normal upright orientation and the head portion 32 can be directed through the lateral slot extension 28.

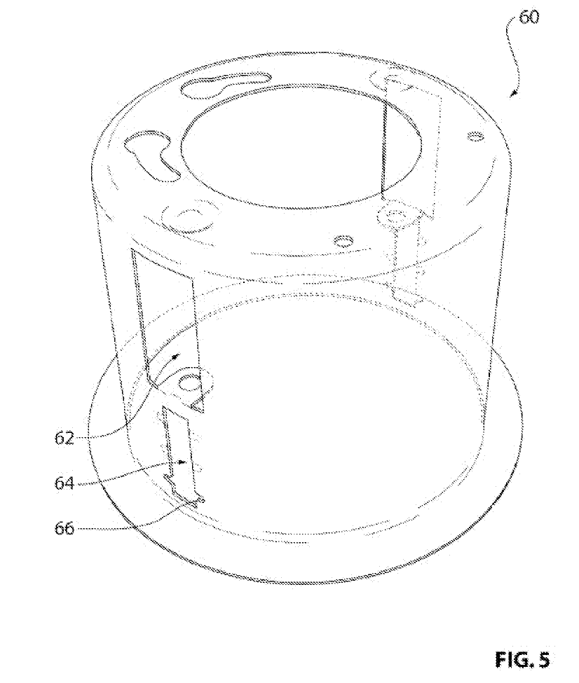

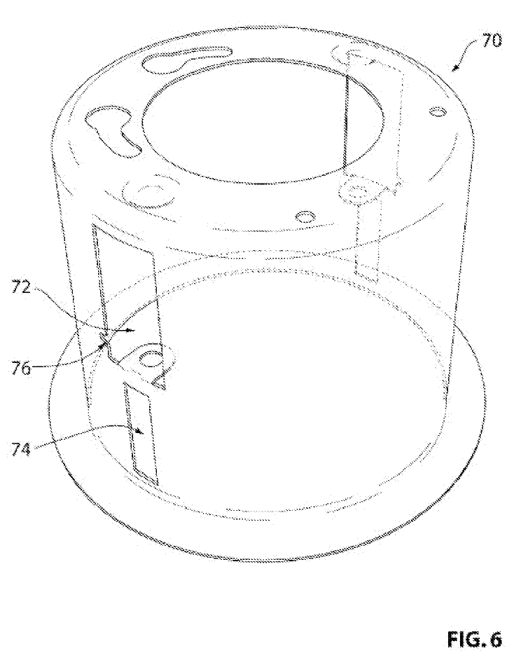

Another housing is shown at 60 in FIG. 5 having upper and lower slot portions 62, 64. In this case, the lower slot portion 64 is provided with a pair of lateral slot extensions 66 which are shown in three alternative exemplified positions. In this case, the slot extensions 66 are dimensioned to receive the anchor flange 44 of the retaining clip 30.

Thus, with this arrangement, it can be appreciated that the retaining clip 30 may be installed by first tilting the head portion 32 to pass through the upper slot portion 62. The retaining clip 30 may then be righted to its normal upright orientation and the anchor flange 44, then passed through the slot extensions 66. It will be understood that, in this arrangement, the anchor flange 44 and the slot extensions 66 will require complementary dimensions. For instance, the anchor flange may be shaped to pass through the slot extensions 66 in a first entry orientation and then operate therein in second operative orientation where the relative shape and/or dimensions of the anchor flange 44 and slot extensions 66 permit the former to travel along the lower slot without passing back through the slot extensions 66.

Another housing is shown at 70 in FIG. 6 having upper and lower slot portions 72, 74. In this case, the upper slot portion 72 is provided with a single lateral slot extension 76 and is dimensioned to receive one side of the edge region 32a of the retaining clip 30 where the other side of the edge region 32a and the anchor flange 44 are already inside the corresponding upper and lower slot portions 72, 74.

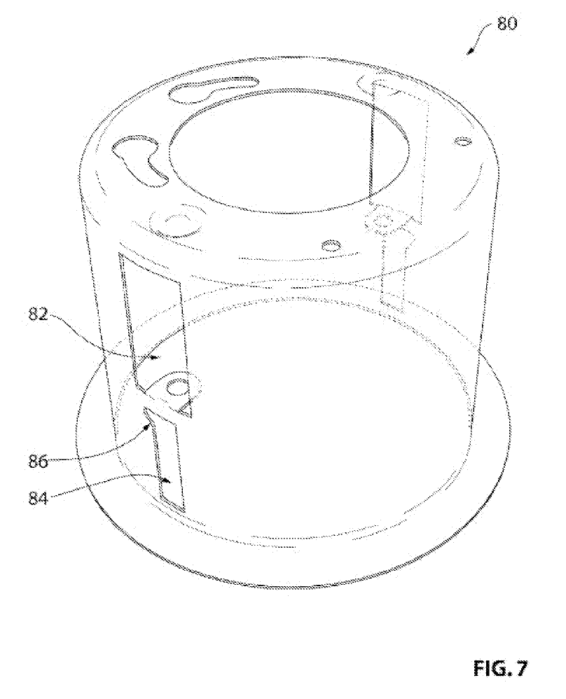

Another housing is shown at 80 in FIG. 7 having upper and lower slot portions 82, 84. In this case, the lower slot portion 84 is provided with a single lateral slot extension 86 and is dimensioned to receive one side of the anchor flange 44 (not shown) where the head portion 32 and end regions 32a are inside upper slot portion 82 and one side of anchor flange 44 is inside lower slot portion 84.

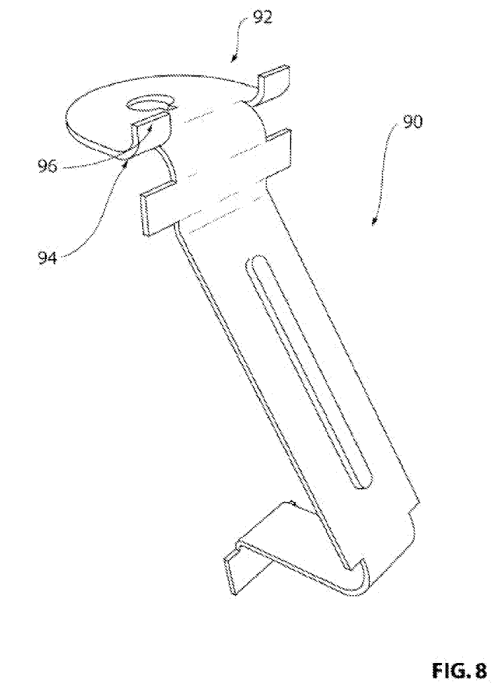

Another variation of the retaining clip is shown in FIG. 8 at 90 having a head portion 92 with a pair of contact regions 94 for contacting an inner surface of the corresponding side wall portion of the housing (not shown). The head portion 92 further includes a pair of ears 96, each located adjacent a corresponding contact region.

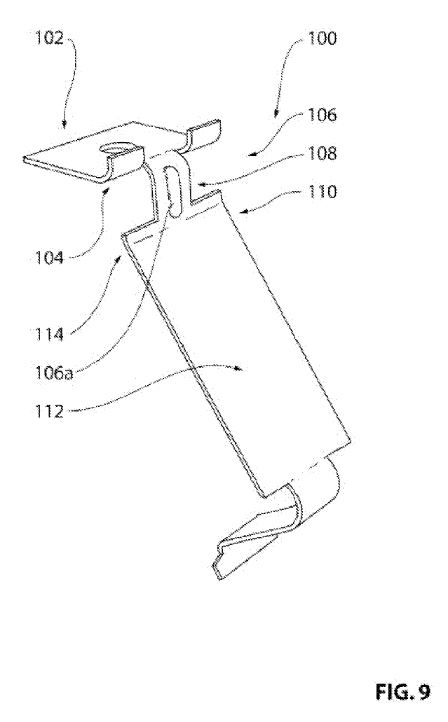

Still another retaining clip is shown in FIG. 9 at 100. In this case, the clip 100 has a head portion 102 with a pair of ears 104, each located adjacent a corresponding contact region. The clip has a neck portion 106 with an upper portion 108 that is relatively narrow and a lower collar portion 110 joined to a body portion 112. In this case, the collar and body portions 110, 112 are joined at a bend 114 and are of equal lateral dimension. The neck portion 106 is further provided with a central ridge 106a for stiffening purposes.

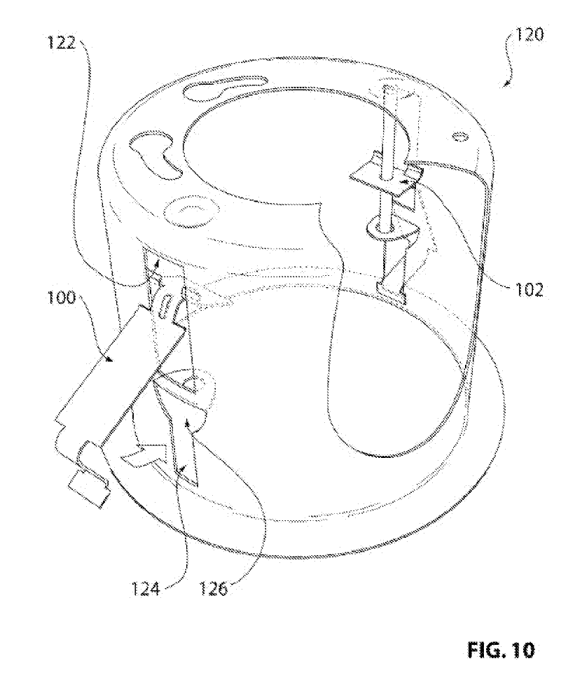

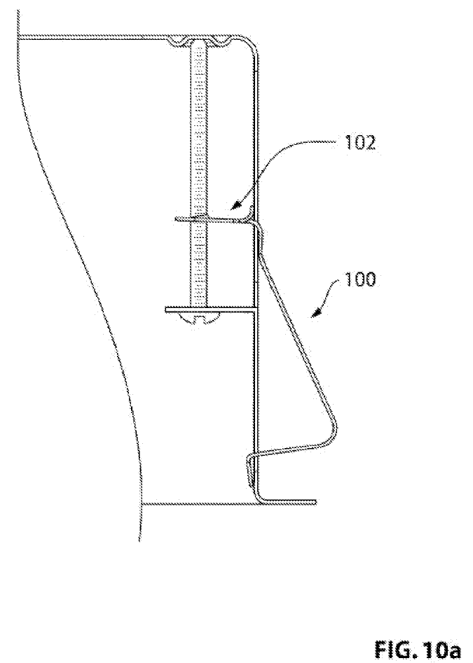

FIG. 10 shows retaining clip 100 in a housing 120 having an upper slot portion 122, a lower slot portion 124 with a relatively large upper region 126. Thus, with this arrangement, the retaining clip 100 may be installed by first tilting the head portion 102 to pass through the upper slot portion 122. The retaining clip 100 may then be righted to its normal upright orientation and the anchor flange 44 passed through the upper region 126.

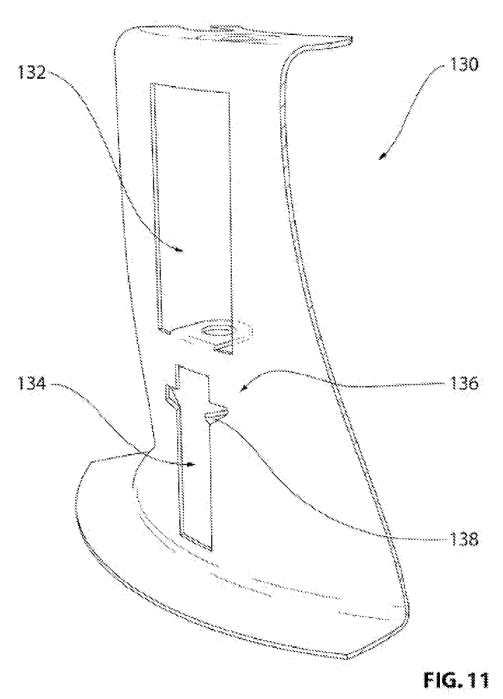

A portion of another housing is shown at 130 in FIG. 11 having upper and lower slot portions 132, 134. In this case, the lower slot portion 134 is provided with a pair of lateral slot extensions 136 that is formed by a notch 138 which is cut from the side wall of the housing and bent outwardly. This arrangement has the advantage of providing a further barrier against an inadvertent release of the anchor flange from its operative position within the lower slot portion.

Thus, the recessed light fixture 10 is used as follows. First, two retaining clamps 30 are installed as required in the housing 12 and the adjusting screws 52 are set so that the head portions 32 are located near the back wall 14 to increase the distance between the anchor flange 44 and the lower lip 18, to maximize the spacing for a ceiling layer to be located therebetween. Next, housing is installed in a suitable prepared passage in a ceiling. As the housing penetrates the passage, the body portions 36 of the retaining clip 30 are flexed inwardly toward the housing wall 16. In some cases, if the ceiling hole is tight against the housing, the clips may slide down the slots rather than flex inwardly towards the housing wall. Therefore, in cases like this, it may be useful for the installer to manually hold body portion 36 of clips 30 against wall 16 of housing while inserting housing into passage of ceiling. Once the bend 42a passes through the passage, the body portion 36 of retaining clip 30 then returns to its original outwardly biased position. The adjusting screw 52 is then turned to draw the head portion 32 away from the back wall 14, thereby bringing the anchor portion 42 closer toward the lower lip 18 until the ceiling layer is firmly held there between.

While the present invention has been described for what are presently considered the preferred embodiments, the invention is not so limited. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A recessed lighting fixture, comprising a housing having a back wall, one or more side walls extending from the back wall and at least one lower lip extending outwardly from one of said side walls, one or more of said side walls including at least one elongate slot formation, the slot formation including aligned upper and lower slot portions, the upper and/or lower slot portions having a pair of oppositely extending slot boundary regions, at least one slot boundary region having a lateral slot extension therein, the slot extension having a first elongate dimension, a retaining clip for mounting in the slot formation for movement therealong, the retaining clip having a head portion, a neck portion and a body portion, the neck portion being dimensioned to extend through the upper slot portion and the head portion arranged to travel along an inner surface of the corresponding side wall on opposite sides of the upper slot portion, the neck portion including a collar portion, the collar portion including one or more that one projection extending laterally outwardly from the neck portion, the collar portion having a second elongate dimension exceeding the first elongate dimension to permit the collar portion to travel on an outer surface of a corresponding wall over the lateral slot extension, the body portion arranged to be biased outwardly from the housing portion and joined to an anchor portion, the anchor portion extending through the lower slot portion with an anchor flange, the anchor flange being arranged to travel along an inner surface of the corresponding side wall on opposite sides of the lower slot portion, the head and/or anchor portions being dimensioned to pass through a corresponding slot extension in the upper and/or lower slot portions.

2. A fixture as defined in claim 1, wherein the upper slot portion has a pair of opposed lateral slot extension.

3. A fixture as defined in claim 2, wherein the collar portion includes a pair of opposed projections.

4. A fixture as defined in claim 3, wherein the body portion has a relatively smaller lateral dimension than the collar portion.

5. A fixture as defined in claim 3, wherein the lateral slot extensions are located in a lower region of the upper and/or lower slot portions.

6. A fixture as defined in claim 3, wherein the lateral slot extensions are located in an upper region of the upper and/or lower slot portions.

7. A fixture as defined in claim 3 wherein the lateral slot extensions are located in a central region of the upper and/or lower slot portions.

8. A fixture as defined in claim 3 wherein the lateral slot extensions are located in the upper slot portion, each slot extension having a first elongate dimension.

9. A fixture as defined in claim 8, wherein the projection has a second elongate dimension that exceeds the first elongate dimension.

10. A fixture as defined in claim 9 wherein the head portions including a pair of contact regions for contacting inner surface of the corresponding side wall portion, the head portions further comprising a pair of ears, each located adjacent a corresponding contact region.

11. A fixture as defined in claim 10, further comprising a mounting flange extending inwardly from a lower periphery of the upper slot portion.

12. A fixture as defined in claim 11, the head portion further comprising a first passage, the mounting flange having a second passage, and a fastener threadably engaged with and extending through the first and/or second flanges for adjusting the head portion relative to the mounting flange.

13. A fixture as defined in claim 1, wherein the upper slot portion is wider than the lower slot portion.

14. A fixture as defined in claim 1, wherein the upper slot portion is narrower than the lower slot portion.

15. A fixture as defined in claim 1, wherein the collar portion and the body portion are of equal lateral dimension.

16. A fixture as defined in claim 3 wherein the collar portion and the body portion are joined at a bend.

17. A retaining clip for use in a recessed lighting fixture of the type having a housing with at least one side wall, one or more of said side walls including aligned upper and lower slot portions, the upper and/or lower slot portions having a pair of oppositely extending slot boundary regions, at least one slot boundary region having a lateral slot extension therein, the slot extension having a first elongate dimension, the retaining clip arranged for mounting in the slot formation for movement therealong, the retaining clip comprising a head portion, a neck portion and a body portion, the neck portion being dimensioned to extend through the upper slot portion and the head portion arranged to travel along an inner surface of the corresponding side wall on opposite sides of the upper slot portion, the neck portion including a collar portion, the collar portion including one or more than one projection extending laterally outwardly from the neck portion, the collar portion having a second elongate dimension exceeding the first elongate dimension to permit the collar portion to travel on an outer surface of a corresponding wall over the lateral slot extension, the body portion arranged to be biased outwardly from the housing portion and joined to an anchor portion, the anchor portion extending through the lower slot portion with an anchor flange, the anchor flange being arranged to travel along an inner surface of the corresponding side wall on opposite sides of the lower slot portion, the head and/or anchor portions being dimensioned to pass through a corresponding slot extension in the upper and/or lower slot portions.

18. A method of forming a recessed lighting fixture, comprising the steps of:
providing a housing with a back wall, one or more side walls extending from the back wall and at least one lower lip extending outwardly from one of said side walls;
providing one or more of said side walls with aligned upper and lower slot portions,
providing at least one lateral slot extension in a boundary region of at least one slot boundary regions and with a first elongate dimension,
providing a retaining clip for mounting in the upper and lower slot portions with a head portion, a neck portion and a body portion;
providing the neck portion with a dimension allowing it to extend through the upper slot portion, so that the head portion can travel along an inner surface of the corresponding side wall on opposite sides of the upper slot portion,
providing the neck portion with a collar portion with one or more than one projection extending laterally outwardly therefrom,
providing the collar portion with a second elongate dimension exceeding the first elongate dimension to permit the collar portion to travel on an outer surface of a corresponding wall over the lateral slot extension,
arranging the body portion to be biased outwardly from the housing portion and joined to an anchor portion with an anchor flange,
arranging the anchor portion to extend through the lower slot portion with an anchor flange,
arranging the anchor flange to travel along an inner surface of the corresponding side wall on opposite sides of the lower slot portion, and
arranging the head and/or anchor portions being dimensioned to pass through a corresponding slot extension in the upper and/or lower slot portions.

19. A method of forming a recessed lighting fixture, comprising the steps of:
providing a housing with a back wall, one or more side walls extending from the back wall and at least one lower lip extending outwardly from one of said side walls;
providing one or more of said side walls with aligned upper and lower slot portions,
providing at least one lateral slot extension in a boundary region of at least one slot boundary regions and with a first elongate dimension,
providing a retaining clip for mounting in the upper and lower slot portions with a head portion, a neck portion and a body portion, the neck portion having a dimension allowing it to extend through the upper slot portion, so that the head portion can travel along an inner surface of the corresponding side wall on opposite sides of the upper slot portion, the neck portion having a collar portion with one or more than one projection extending laterally outwardly therefrom, the collar portion having a second elongate dimension exceeding the first elongate dimension, the body portion being arranged to be biased outwardly from the housing portion and joined to an anchor portion with an anchor flange on a free end region thereof,
installing the chip on the housing by passing the head and/or anchor portions through a corresponding slot extension in the upper and/or lower slot portions, so that the anchor flange is able to travel along an inner surface of the corresponding side wall on opposite sides of the lower slot portion, and to enable the collar portion to travel on an outer surface of a corresponding wall over the lateral slot extension.

20. A method of forming a recessed lighting fixture, comprising:
a step for providing a housing with a back wall, one or more side walls extending from the back wall and at least one lower lip extending outwardly from one of said side walls, a step for providing one or more of said side walls with aligned upper and lower slot portions, and at least one lateral slot extension in a boundary region of at least one slot boundary regions and with a first elongate dimension.
a step for providing a retaining clip for mounting in the upper and lower slot portions with a head portion, a neck portion and a body portion, the neck portion having a dimension allowing it to extend through the upper slot portion, so that the head portion can travel along an inner surface of the corresponding side wall, the neck portion having a collar portion with one or more than one projection extending laterally outwardly therefrom, the collar portion having a second elongate dimension exceeding the first elongate dimension; the body portion being arranged to be biased outwardly from the housing portion and joined to an anchor portion with an anchor flange on a free end region thereof, and
a step for installing the clip on the housing by passing the head and/or anchor portions through a corresponding slot extension in the upper and/or lower slot portions, so that the anchor flange is able to travel along an inner surface of the corresponding side wall on opposite sides of the lower slot portion, and to enable the collar portion to travel on an outer surface of a corresponding wall over the lateral slot extension.

21. A recessed lighting fixture, comprising housing means having a back wall means, one or more side wall means extending from the back wall means and at least one lower boundary means extending outwardly from one of said side wall means, one or more of said side wall means including at least one elongate slot means, the slot means including aligned upper and lower slot portions, the upper and/or lower slot portions having a pair of oppositely extending slot boundary regions, at least one slot boundary region having a lateral slot extension therein, the slot extension having a first elongate dimension, a retaining means for mounting in the slot means for movement therealong, the retaining means having a head portion, a neck portion and a body portion, the neck portion being dimensioned to extend through the upper slot portion and the head portion arranged to travel along an inner surface of the corresponding side wall on opposite sides of the upper slot portion, the neck portion including a collar portion, the collar portion including one or more than one guide means extending laterally outwardly from the neck portion, the collar portion having a second elongate dimension exceeding the first elongate dimension to permit the guide means to travel on an outer surface of a corresponding wall over the lateral slot extension, the body portion arranged to be biased outwardly from the housing portion and joined to an anchor means, the anchor means extending through the lower slot portion with an anchor flange, the anchor flange being arranged to travel along an inner surface of the corresponding wide wall on opposite sides of the lower slot portion, the head and/or anchor portions being dimensioned to pass through a corresponding slot extension in the upper and/or lower slot portions.
